(19) United States
(12) Patent Application Publication
(10) Pub. No.: US 2008/0204535 A1
(43) Pub. Date: Aug. 28, 2008

(54) INK JET PRINTER

(75) Inventor: Yusuke SAKAGAMI, Shiojiri-shi (JP)

Correspondence Address: WORKMAN NYDEGGER, 60 EAST SOUTH TEMPLE, 1000 EAGLE GATE TOWER, SALT LAKE CITY, UT, 84111, US

(73) Assignee: SEIKO EPSON CORPORATION, Tokyo (JP)

(21) Appl. No.: 12/034,337

(22) Filed: Feb. 20, 2008

(30) Foreign Application Priority Data
Feb. 22, 2007 (JP) 2007-041848
Feb. 22, 2007 (JP) 2007-041849
Feb. 22, 2007 (JP) 2007-041850
Dec. 4, 2007 (JP) 2007-313142

(51) Int. Cl. B41J 2/01

(52) U.S. Cl. 347/102

(57) ABSTRACT

An ink jet printer comprising a transporting device that is capable of transporting a print medium with a predetermined width in a first direction, an ink jet head that is capable of ejecting ink drops onto the print medium to execute a printing process, and a drying device that is capable of drying a portion of the printed print medium with a width that is smaller than the width of the print medium that extends from one end of the print medium to a second end of the print medium in the first direction.

### BACKGROUND

The entire disclosure of Japanese Patent Application Nos. 2007-041848, filed Feb. 22, 2007, 2007-041849, filed Feb. 22, 2007 2007-041850, and 2007-313142, filed Dec. 4, 2007 are expressly incorporated herein by reference.

1. Technical Field

The present invention relates to an ink jet printer. More specifically, the present invention relates to an ink jet printer that is capable of printing on a print medium by ejecting ink drops from the nozzles of an ink jet head of the ink jet printer.

2. Related Art

If plain paper having no dedicated ink receptor layer is used by ink jet printer as a print medium during a printing process, the cellulose fibers within the paper absorb the water acting as an ink solvent, causing a breakdown in the hydrogen bonding between the cellulose fibers and reducing the rigidity of the paper. This decrease in rigidity may cause various difficulties in the printing process, particularly in transporting, turning and ejecting the paper, resulting in a decrease in the reliability of the ink jet printer.

In order to solve these problems, ink jet printers known in the art, including the ink jet printer disclosed in Japanese Patent Application No. JP-A-5-338126, typically blow heated air onto the print medium after the ink drops have been ejected onto the print medium during the printing process in order to dry the print medium. One problem with the ink jet printers of the known art, however, is that they are configured to dry the entire print medium, requiring a great deal of energy. Additionally, the increased need for power may lead to an increase in the size of the ink jet printer.

### BRIEF SUMMARY OF THE INVENTION

A first aspect of the invention comprises an ink jet printer including a transporting device that is capable of transporting a print medium with a predetermined width in a first direction, an ink jet head that is capable of ejecting ink drops onto the print medium to execute a printing process, and a drying device that is capable of drying a portion of the printed print medium. The part of the print medium comprises a line pattern with a width that is smaller than the width of the print medium which extends from an end of the print medium to a second end of the print medium in the first direction.

A second aspect of the invention is an ink jet printer comprising a transporting device that is capable of transporting a print medium with a predetermined width in a first direction, an ink jet head that is capable of ejecting ink drops onto the print medium to execute a printing process, a drying-pattern setting section that is capable of selecting a drying pattern for drying the printed print medium by evaluating the ink drops ejected onto the print medium, and a drying executing section that is capable of drying a portion of the print medium corresponding to the drying pattern selected by the drying-pattern setting section.

A third aspect of the invention is an ink jet printer comprising a transporting device that is capable of transporting a print medium with a predetermined width in a first direction, an ink jet head that is capable of ejecting ink drops onto the print medium to execute a printing process, a heating roller with a width that is smaller than the predetermined width of the print medium that contacts the print medium that is capable of drying a portion of the print medium, and a roller heating device that is capable of heating the heating roller.

A fourth aspect of the invention is an ink jet printer comprising a transporting device that is capable of transporting a print medium with a predetermined width in a first direction, an ink jet head that is capable of ejecting ink drops onto the print medium to execute a printing process, and a drying device that is capable of drying only a portion of the printed print medium without making contact with the print medium.

As described more fully below, one advantage of aspects of the invention is a printer that is capable of restoring the rigidity of the print medium whose rigidity is decreased during the printing process while preventing the print medium from getting stained and reducing the energy required for drying.

### BRIEF DESCRIPTION OF THE DRAWINGS

The invention will be described with reference to the accompanying drawings, wherein like numbers reference like elements.

FIG. 1 is a schematic diagram of an ink jet printer according to a first embodiment;

FIG. 2A is a schematic top view of a perforated rotating drum;

FIG. 2B is a schematic front view of the perforated rotating drum;

FIG. 3A is a schematic front view of a heating unit;

FIG. 3B is a schematic side view of the heating unit;

FIG. 4 is a block diagram showing the internal structure of the ink jet printer;

FIG. 5 is an enlarged view of the outer circumference of a heating roller;

FIG. 6 is a diagram of the heating roller, with a water-repellent coating on an enlarged scale;

FIG. 7 is a block diagram of the internal structure of an inverter circuit;

FIG. 8A is a diagram for describing the operation of the inverter circuit;

FIG. 8B is a diagram for describing the operation of the inverter circuit;

FIG. 8C is a diagram for describing the operation of the inverter circuit;

FIG. 8D is a diagram for describing the operation of the inverter circuit;

FIG. 9 is a schematic diagram of an experimental device for measuring the degree of recovery of the rigidity of a print medium;

FIG. 10 is a graph showing the measurements by the experimental device;

FIG. 11 is a diagram for describing the dried state of the print medium used in the experiment;

FIG. 12 is a schematic diagram of a modification of the heating unit;

FIG. 13 is a schematic diagram of a modification of the heating unit;

FIG. 14A is a diagram for describing the operation of the modification of the control circuit;

FIG. 14B is a diagram for describing the operation of the modification of the control circuit;

FIG. 14C is a diagram for describing the operation of the modification of the control circuit;

FIG. 15 is a schematic diagram of a modification of the heating unit;

FIG. 16 is a schematic diagram of a modification of the heating roller;

FIG. 17 is a schematic diagram of a double-sided ink jet printer;

FIG. 18 is a block diagram showing the internal structure of the ink jet printer in FIG. 17;

FIG. 19 is a schematic diagram of an ink jet printer according to a second embodiment;

FIG. 20 is a block diagram showing the internal structure of the ink jet printer in FIG. 19;

FIG. 21 is a schematic front view of a heating unit of this embodiment;

FIG. 22 illustrates the timing at which light is emitted from a light source;

FIG. 23 is a schematic side view of a modification of the heating unit;

FIGS. 24A-24H are diagrams illustrating the operation of the heating unit;

FIG. 25 is a schematic side view of a modification of the heating unit;

FIG. 26 is a schematic side view of a modification of the heating unit;

FIG. 27A is a schematic perspective view of a modification of the heating unit;

FIG. 27B is a schematic side view of the modification of the heating unit;

FIG. 28 is a diagram for describing the timing at which light is emitted from a light source;

FIG. 29 is a schematic diagram of a double-sided ink jet printer;

FIG. 30 is a block diagram showing the internal structure of the ink jet printer in FIG. 29;

FIG. 31 is a diagram for describing print areas set to a print medium;

FIG. 32 is a diagram for describing the sizes of ink drops for printing;

FIG. 33 is a flowchart for a control process;

FIG. 34 is a flowchart for a pattern setting process;

FIGS. 35A-35H are diagrams describing various heating patterns;

FIG. 36 is a flowchart for a modification of the pattern setting process;

FIGS. 37A-37H are diagrams describing various embodiments of heating patterns; and

FIGS. 38A-38K are additional diagrams describing additional embodiments of heating patterns.

### DESCRIPTION OF EXEMPLARY EMBODIMENTS

Embodiments of the present invention will be described with reference to the drawings.

### First Embodiment

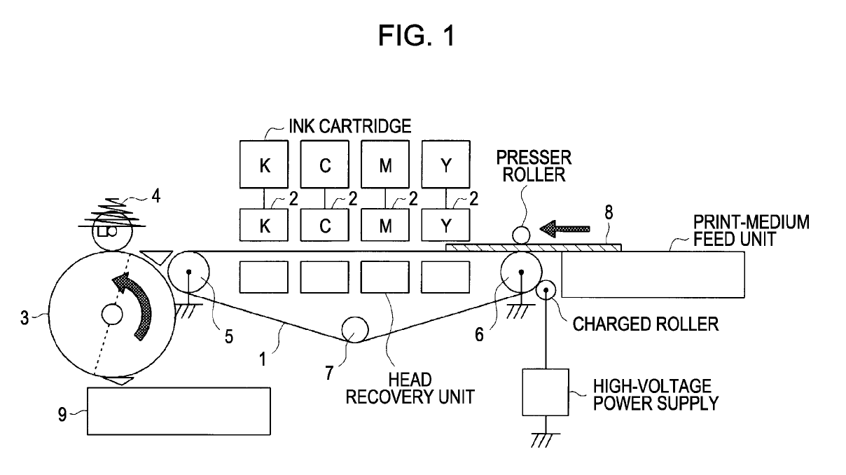

FIG. 1 is a schematic diagram of a single-sided ink jet printer according to a first embodiment of the invention. As shown in FIG. 1, the ink jet printer includes a transportation belt 1, a plurality of ink jet heads 2, a perforated rotating drum 3, and a heating unit 4.

The transportation belt 1 is wound around a driving roller 5, a driven roller 6, and a tension roller 7 and is rotated by a transportation belt motor (not shown). A print medium 8 is fed into the printer by a print-medium feed unit and is transported to the transportation belt 1 by a presser roller and the driven roller 6. The print medium 8 passes below the ink jet heads 2 onto the perforated rotating drum 3 by being attached to the transportation belt 1 via electrostatic force, air suction, or the like. In FIG. 1, the print medium 8 is transported from the right to left, as shown by the arrow. In this embodiment, a charged roller having a high-voltage power supply is in contact with the transportation belt 1 so as to generate static electricity.

Yellow (Y), magenta (M), cyan (C), and black (K) ink jet heads 2 are disposed above the transportation belt 1 in the direction corresponding to the direction of transportation of the print medium 8 by the transportation belt 1. Ink cartridges and head recovery units corresponding to the ink jet heads 2 are provided so as to supply the ink jet heads 2.

The ink jet printer executes a printing operation by ejecting the necessary amount of ink drops from multiple nozzles provided in a direction which is orthogonal to the direction the print medium 8 is being transported on the transportation belt 1, so as to form fine ink dots onto the print medium 8.

The perforated rotating drum 3 is disposed at the end of the transportation belt 1, and is configured so as to rotation in the same direction as the transportation belt 1.

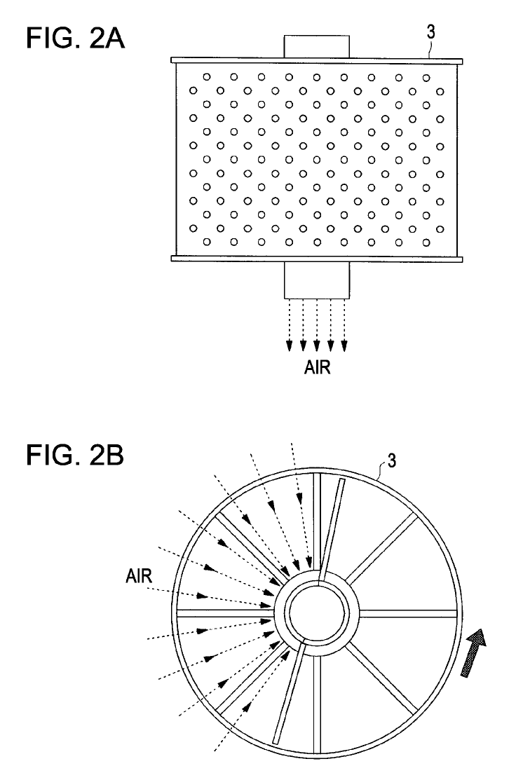

FIGS. 2A and 2B are schematic diagrams of the perforated rotating drum 3. FIG. 2A is a top view of the perforated rotating drum 3, and FIG. 2B is a front view of the perforated rotating drum 3.

As shown in FIGS. 2A-2B, the perforated rotating drum 3 sucks air through holes using a suction fan or the like. The broken-line arrow indicates the direction of air flow. The perforated rotating drum 3 is rotated in the direction of the solid-line arrow by a drum motor (not shown).

Returning to FIG. 1, after the printed print medium 8 is transported by the transportation belt 1 during the printing process, the printed print medium is sucked onto the perforated rotating drum 3, where the perforating rotating drum 3 rotates half a turn in the counterclockwise direction, wherein it is transported to an output section 9 located below the perforated rotating drum 3.

The heating unit 4 comes into contact with the printed print medium 8 transported by the perforated rotating drum 3 so as to dry only a portion of the print medium 8.

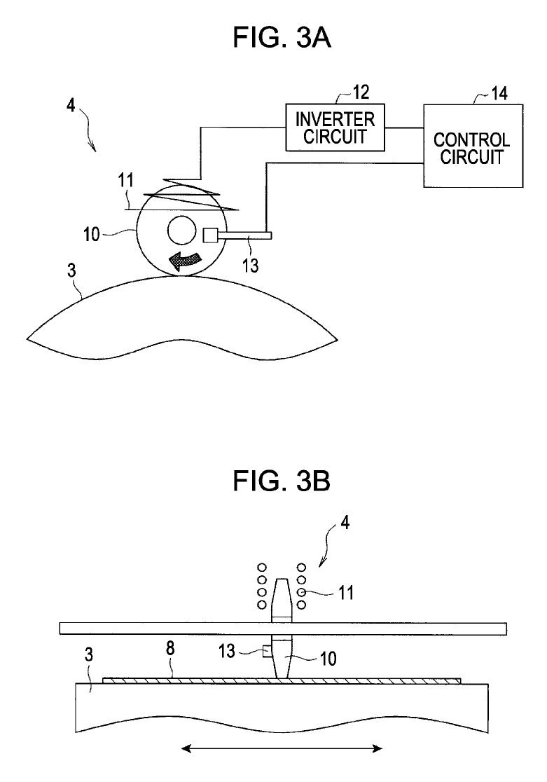

FIGS. 3A and 3B are schematic diagrams of the heating unit 4. FIG. 3A is a front view, and FIG. 3B is a side view thereof. As shown in FIG. 3A, the heating unit 4 includes a heating roller 10, a heating coil 11, an inverter circuit 12, a temperature sensor 13, and a control circuit 14. As shown in FIG. 3B, the heating unit 4 continuously dries the print medium 8 by drying only a portion of the print medium 8 at a time.

The heating roller 10 is formed of a high magnetic-permeability metallic material such as carbon steel, electromagnetic soft iron, silicon steel, or electromagnetic stainless steel into a roller shape with a small diameter. Specifically, the heating roller 10 has the shape of a roller whose length is smaller than the width of the print medium 8.

As shown in FIG. 3B, the heating roller 10 is disposed parallel to the rotating drum 3 so as to rotate with the rotating drum 3 such the print medium 8 in contact with both rotating drum 3 and heating roller 10.

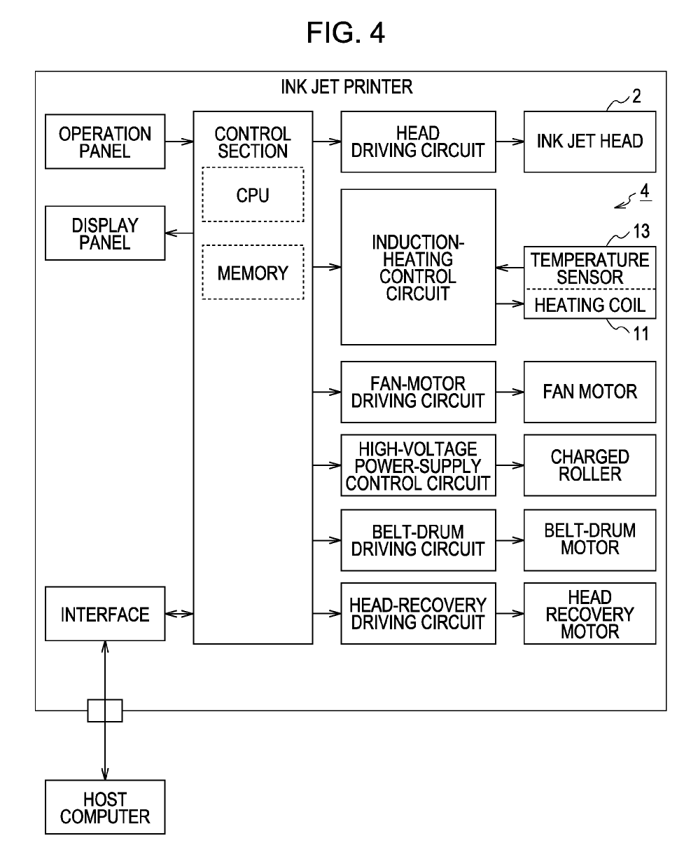

FIG. 4 is a block diagram showing the internal structure of the ink jet printer. As shown in FIG. 4, the ink jet printer includes a control section having a CPU and a memory, by which the ink jet printer exchanges information with a host computer via an interface. The control section is also capable of receiving commands from an operation panel of the ink jet printer. The information from the control section is displayed on a display panel.

The control section controls a head driving circuit, an induction-heating control circuit, a fan-motor driving circuit, a high-voltage power supply/control circuit, a belt-drum driving circuit, and a head-recovery driving circuit.

The ink jet heads 2 are driven by the head driving circuit. The heating unit 4 is controlled by the induction-heating control circuit. The induction-heating control circuit includes the inverter circuit 12 and the control circuit 14 shown in FIG. 3A.

The fan-motor driving circuit drives a motor for the suction fan. The high-voltage power supply/control circuit controls the voltage in order to control the amount of electrostatic charge applied to the charged roller.

The belt-drum driving circuit drives a belt-drum motor which in turn drives the transportation belt 1 and the rotating drum 3, shown in FIG. 1. The head-recovery driving circuit drives a head recovery motor for the head recovery unit, and the heating unit 4 will be more specifically described below.

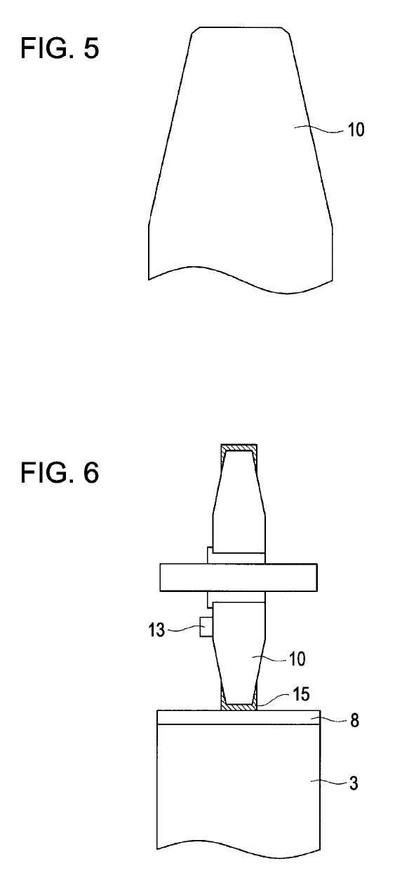

FIG. 5 is an enlarged view of the outer circumference of the heating roller 10. FIG. 6 is a diagram of the heating roller 10, drawn at an enlarged scale so as to illustrate a water-repellent coating 15 on the heating roller 10. As shown in FIG. 5, the outer circumference of the heating roller 10 which contacts the print medium 8 has tapered or curved corners on the end portion.

As shown in FIG. 6, the heating roller 10 has a water-repellent coating 15. Preferably, the coating is made of polytetrafluoroethylene (PTFE), tetrafluoroethylene-perfluoroalkylvinylether copolymer (PFA: perfluoroalkoxy), ethylene tetrafluoroethylene copolymer (ETFE), tetrafluoroethylene-hexafluoropropylene copolymer (FEP: fluorinated ethylene propylene), silicon rubber, or fluoro rubber.

Returning to FIGS. 3A and 3B, the heating coil 11 is disposed so as to cover the heating roller 10. Specifically, the heating coil 11 is wound around the heating roller 10 in such a manner that the distance from the heating roller 10 is fixed.

The heating of the heating roller 10 is executed as follows. First, when electricity is supplied from the inverter circuit 12, an AC magnetic field is generated around the heating roller 10. Then, the heating coil 11 generates an eddy current around the heating roller 10 by the AC magnetic field, by which heat is generated via the electric resistance of the heating coil 11, which is then transferred to the heating roller 10.

The AC magnetic field generated by the heating coil 11 is concentrated in the surface of the heating roller 10 to a depth, or thickness δ of the heating roller 10, which is expressed by Eq. 1.

δ=(ρ/(πfμ))^{1/2} Eq. 1

where, ρ is the electric resistance of the heating roller 10, μ is the magnetic permeability, and f is the frequency of the AC magnetic field.

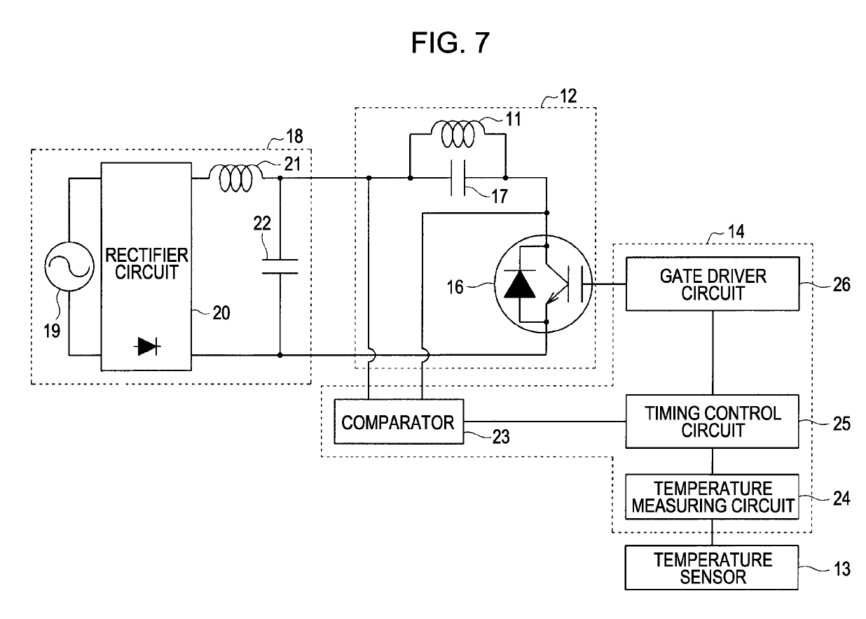

FIG. 7 is a block diagram of the internal structure of the inverter circuit 12, the temperature sensor 13, and the control circuit 14. The inverter circuit 12 connects to a DC supply 18 and the control circuit 14. The temperature sensor 13 connects to the control circuit 14. The DC supply 18 rectifies AC voltage obtained from a commercial power supply 19 with a rectifier circuit 20, smoothes it with a choke coil 21 and a capacitor 22, and sends it to the inverter circuit 12 as DC voltage.

The inverter circuit 12 includes an insulated gate bipolar transistor (IGBT) 16 and a resonant capacitor 17. The IGBT 16 is configured such that the emitter connects to a first electrode of the DC supply 18, the collector connects to a first end of the heating coil 11 and a first electrode of the resonant capacitor 17, and the gate connects to a gate driver circuit 26 (described later) of the control circuit 14.

The first electrode of the resonant capacitor 17 connects to the first end of the heating coil 11 and the collector of the IGBT 16, while a second end of the resonant capacitor 17 connects to a second end of the heating coil 11 and a second electrode of the DC supply 18.

The control circuit 14 includes a comparator 23, a temperature measuring circuit 24, a timing control circuit 25, and a gate driver circuit 26.

The comparator 23 determines whether the voltage of the heating coil 11 has become larger than a predetermined threshold, and outputs the determination to the timing control circuit 25.

The temperature measuring circuit 24 measures the temperature of the heating roller 10 on based on the measurement output from the temperature sensor 13, and outputs the measurement to the timing control circuit 25.

The timing control circuit 25 executes a coil heating control process, described more fully below, and outputs an instruction to control the gate voltage of the IGBT 16 according to the comparison result output from the comparator 23 and the temperature output from the temperature measuring circuit 24 to the gate driver circuit 26 so as to generate voltage resonance between the heating coil 11 and the resonant capacitor 17, causing a current to flows in the heating coil 11. The gate driver circuit 26 controls the gate voltage of the IGBT 16 according to the instruction output from the timing control circuit 25.

The temperature sensor 13 comprises a thermistor, a thermocouple, or another element, which is retained by a spring (not shown) so as to be in stable contact with the surface of the heating roller 10 in order to measure the temperature of the heating roller 10, which the temperature sensor 13 then outputs to the control circuit 14.

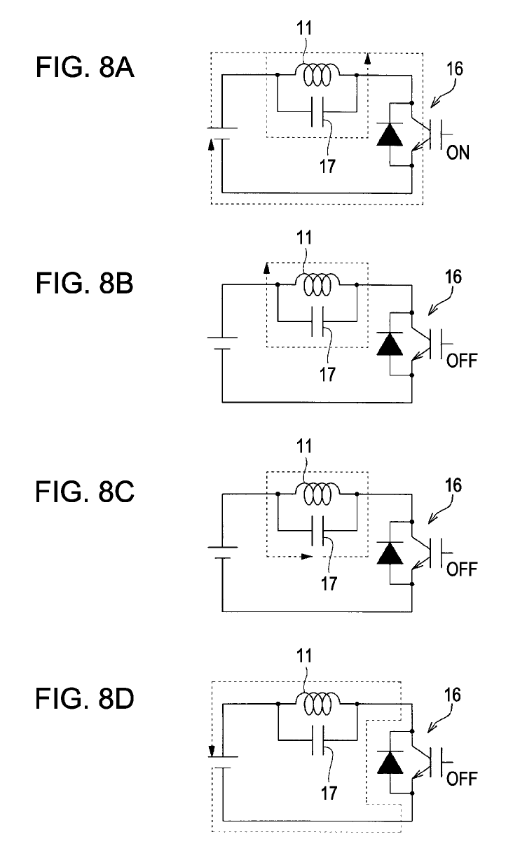

The coil heating control process executed by the timing control circuit 25 will be described next with reference to FIG. 7 and FIGS. 8A to 8D. FIGS. 8A to 8D illustrate the operation of the inverter circuit 12. As shown in FIG. 8A, when the coil heating control process is executed, the timing control circuit 25 outputs an instruction to control the gate voltage of the IGBT 16 to the gate driver circuit 26 so that the IGBT 16 is turned on, causing current to flow between the collector and the emitter, allowing current to pass through the heating coil 11 and the resonant capacitor 17. Thus the heating coil 11 is rapidly charged by the supply voltage, according to Eq. 2.

i(t)=(E/R)(1−e^{-(R/L)T}) Eq. 2

where R is the resistance of the heating coil 11, E is DC current, and L is the inductance of the heating coil 11.

Referring next to FIGS. 8B and 8C, when the determination that the voltage of the heating coil 11 has become larger than a predetermined threshold value, a signal is output from the comparator 23, causing the timing control circuit 25 to output an instruction to control the gate voltage of the IGBT 16 to the gate driver circuit 26 so that the IGBT 16 is turned off. Thus, no current flows between the collector and the emitter, and the magnetic energy accumulated in the heating coil 11 to the resonant capacitor 17 is moved to the resonant capacitor 17.

Referring to FIG. 8D, after the discharge of the resonant capacitor 17 is completed so that the voltage of the resonant capacitor 17 becomes low, current flows through the heating coil 11 by the free wheel diode of the IGBT 16 to charge the heating coil 11.

By repeating this process, voltage resonance continues to occur between the heating coil 11 and the resonant capacitor 17, so that a current flows continuously through the heating coil 11.

### EXAMPLE

An experiment aimed at measuring the rigidity of the partially dried print medium 8 to verify the effect of partially drying the print medium 8 by the heating unit 4 will now be described.

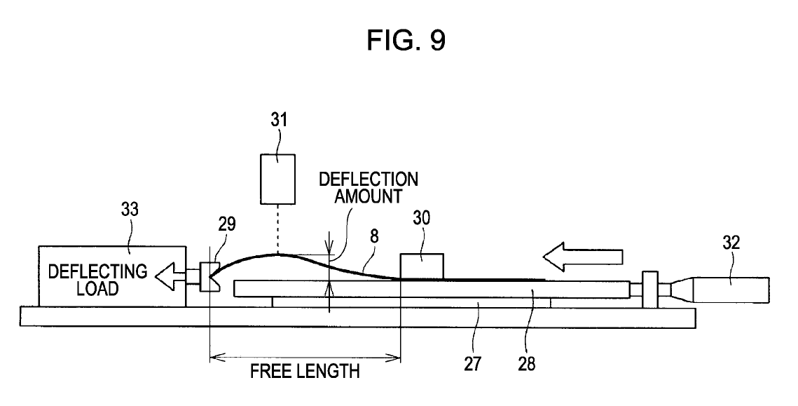

In this experiment, as shown in FIG. 9, the print medium 8 is placed on a moving plate 28 that can be moved by a slider 27, where it is adjusted so that the end of the print medium 8 comes into contact with a paper receiver 29. Then, a presser plate 30 is placed on the print medium 8 to secure the print medium 8. Next, the moving plate 28 is moved toward the paper receiver 29 using a micrometer 32 while measuring the amount of deflection of the length of the print medium 8 between the presser plate 30 and the paper receiver 29 using a laser displacement mater 31 until the amount of deflection reaches a predetermined value. When the amount of deflection of the print medium 8 becomes the predetermined value. Then, the load (deflecting load) applied to the paper receiver 29 is measured by a force gage 33, wherein the rigidity of the paper is measured by increasing the deflecting load.

In this experiment, standard paper with a basis weight of 64 g/m² was used as the print medium 8; the amount of ink ejection was set at 2.1 mg/in²; and the free length was set at 105 mm.

Assuming that the basis weight (g/m²) is a fixed value, the free length of the print medium 8 from the presser plate 30 to the paper receiver 29 is a fixed length, and the speed of the moving plate 28 is a fixed value, substantially the same amount of deflection was measured for the print medium 8 prior to printing regardless of the kind of the print medium 8. In other words, the amount of deflection of the print medium 8 before printing depends on the dimension of the print medium 8.

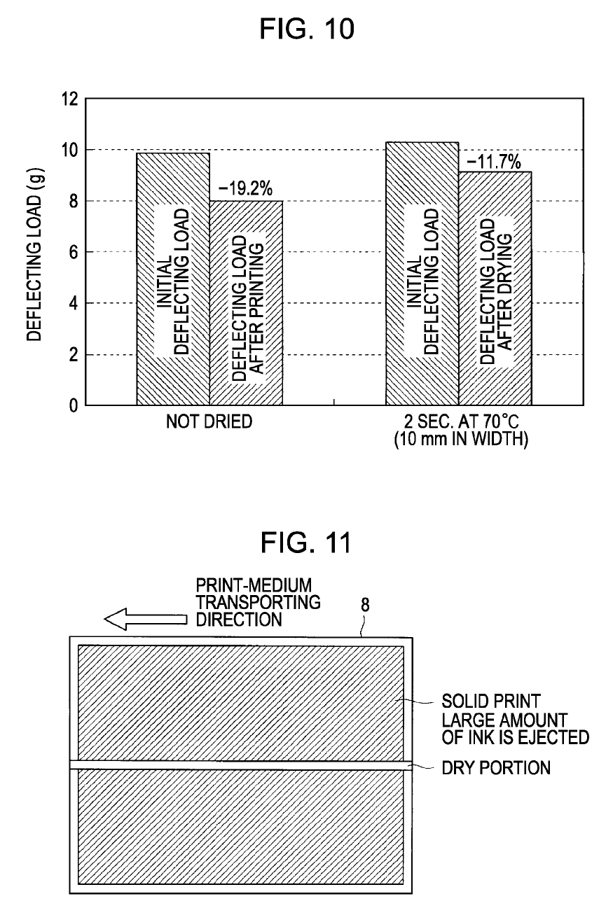

FIG. 10 is a graph showing a comparison between the deflecting load of the print medium 8 before and after printing (before the ink has dried) and a comparison between the deflecting load of the print medium 8 before printing and after the print medium 8 has partially dried by the heating unit 4 of this embodiment.

FIG. 11 shows the print medium 8 that is continuously dried in the transportation direction, in which the print medium 8 was dried in 10 mm wide portions at 70° C. for two seconds.

The graph of FIG. 10 shows that the deflecting load (rigidity) of the print medium 8 directly after printing decreased by 19.2% from that before printing. In contrast, the deflecting load (rigidity) of the print medium 8 that was partly dried by the heating unit 4 of the embodiment decreased by no more than 11.7% from that before printing. This indicates that partially drying the print medium 8 using the heating unit 4 of this embodiment prevents a decrease in deflecting load, thus recovering the rigidity of the print medium 8.

In this embodiment, the heating unit 4 in FIG. 1 corresponds to a drying device and the contact drying device. Likewise, the transportation belt 1 in FIG. 1 corresponds to the transporting device; the heating roller 10 in FIGS. 3A and 3B corresponds to the heating roller; the heating coil 11 in FIGS. 3A and 3B corresponds to the roller heating device; and the water-repellent coating 15 in FIG. 6 corresponds to the water-repellent coating.

Advantages of the embodiment will be described herein below.

1. Since the ink jet printer of this embodiment is configured to dry only portion of the print medium 8 after printing, the rigidity of the print medium 8 can be recovered after a printing process while the energy required for drying is reduced. Using a A4-size print medium 8 that is solidly printed with 0.67-g ink with a moisture content of is 75%, the print medium 8 contains 0.67×0.75=approximately 0.5 g of water. With a latent heat of vaporization 2,404 (J/g) for 40° C., the energy E necessary to evaporate all the water by heating is 1,202 J (E=2,404×0.5=1,202 J).

Table 1 shows the energy per unit time required at every recording velocity (ppm) calculated from the energy E.

TABLE 1

| | Recording Velocity (ppm) | | | | | | |
|---|---|---|---|---|---|---|---|
| | 20 | 40 | 60 | 80 | 100 | 120 | 140 |
| Per- | 3.0 | 1.5 | 1.0 | 0.75 | 0.6 | 0.5 | 0.43 |
| Sheet | | | | | | | |
| Time | | | | | | | |
| (s) | | | | | | | |
| En- | 401 | 802 | 1,202 | 1,603 | 2,003 | 2,404 | 2,795 |
| ergy | | | | | | | |
| (W) | | | | | | | |

2. Since the ink jet printer is configured to dry only portion of the print medium 8 in cross-sections that have a width that is orthogonal to the transportation direction, the rigidity of the print medium 8 can be increased more efficiently.

3. Since the ink jet printer dries a portion of the print medium 8 by contacting the surface of the print medium 8, the energy required for drying is less than the amount required when the print medium 8 is dried without contacting with the surface of the print medium 8.

4. Since the ink jet printer is configured to heat the heating roller 10 using the heating coil 11 by bringing the outer circumference of the heating roller 10 into contact with the print medium 8, only the width of the print medium 8 corresponding to the heating roller 10 is dried, the area of contact between the print medium 8 and the heating roller 10 can be decreased, preventing the adhesion of ink from the print medium to the heating roller 10. Thus, stains on the print medium 8 may be prevented.

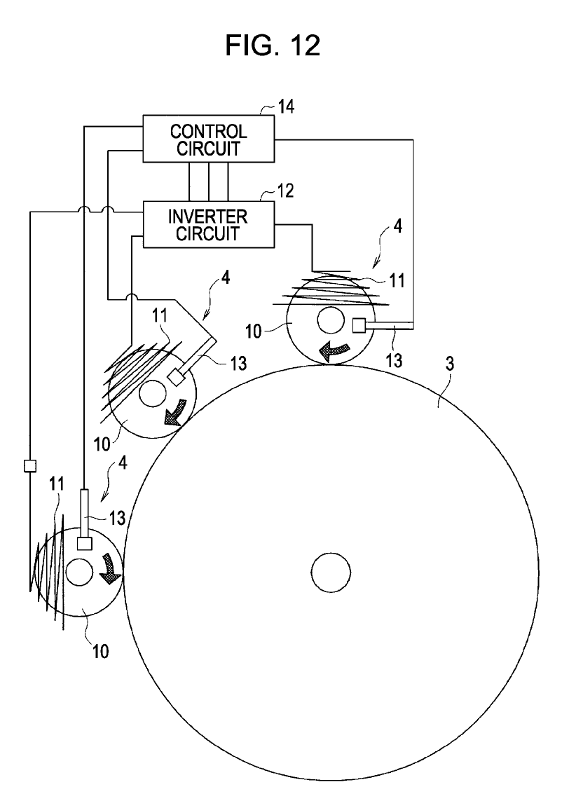

Although this embodiment shows an example in which only one heating unit 4 is provided around the rotating drum 3, the invention is not limited to this configuration. For example, as shown in FIG. 12, three heating units 4 may be disposed in series around the rotating drum 3. This structure allows the print medium 8 to be dried sufficiently to recover the rigidity of the print medium 8 even if the recording velocity of the print medium 8 is so high that the time that the heating roller 10 is in contact with the surface of the print medium 8 is short.

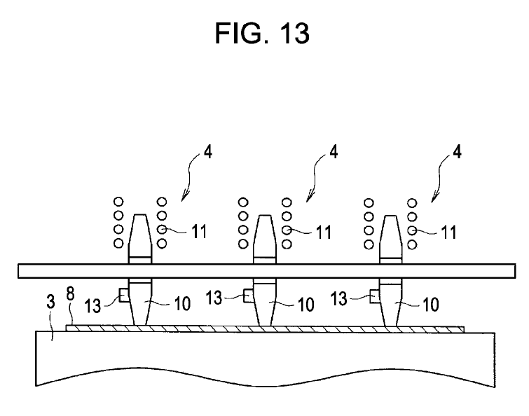

5. As shown in FIG. 13, three heating units 4 may be disposed in parallel around the rotating drum 3. That is, a portion of the print medium 8 may be dried by one rotating drum at each end and center of the width of the portion. Thus, the print medium 8 may be continuously dried in the transportation direction. This structure can increase the rigidity of the print medium 8 more efficiently.

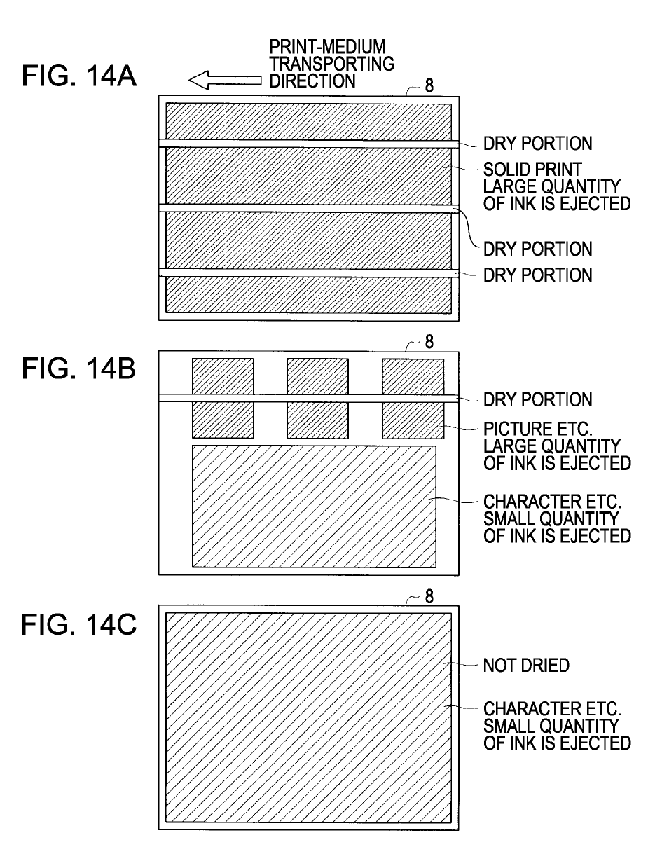

6. In the previously described embodiment, wherein the heating unit 4 is comprised of a plurality of heating units 4 arranged in parallel around the heating drum 3, the heating units 4 may be operated to dry only a portion of the print medium 8, as shown in FIG. 14A. Or, as shown in FIG. 14B, a single heating unit 4 may be used to dry a portion of the print medium 8 where a large quantity of ink is ejected. In other words, the invention may be configured to selectively dry portions of the print medium 8, depending on the density of ink drops on the print medium 8. Thus, the print medium 8 may be selectively dried depending on the density of ink used during the printing process.

7. Since the heating roller 10 is made of magnetic metal, the frequency of the current applied to the heating coil 11 can be decreased.

8. Since the heating coil 11 is wound so that the distance from the heating roller 10 is fixed, the heating coil 11 can generate an appropriate AC magnetic field, so that the heating roller 10 can efficiently generate eddy current.

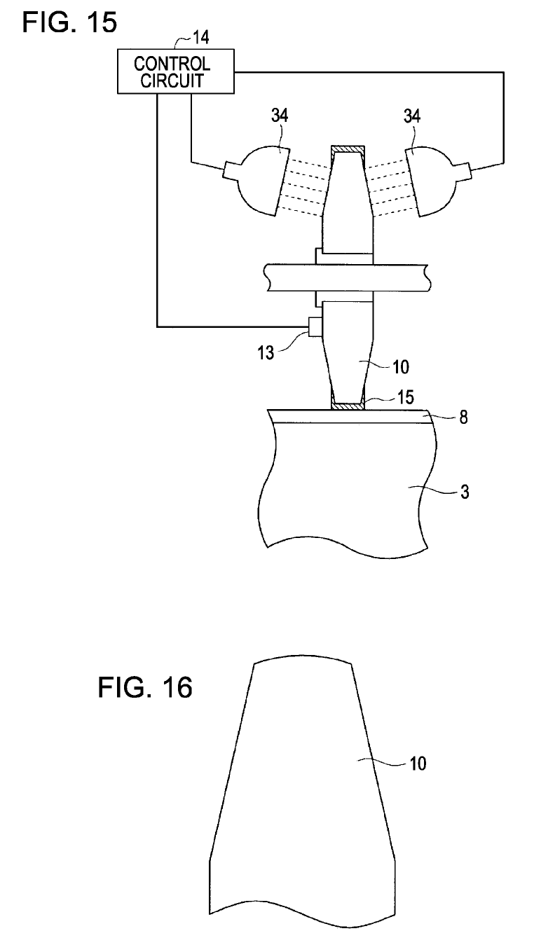

9. Although the previously described embodiments describe a configuration wherein the heating roller 10 is heated by the heating coil 11, the invention is not limited to that configuration. For example, as shown in FIG. 15, the invention may have heating light sources 34 such as halogen lamps or ceramic heaters that radiate far infrared rays, which are radiated to heat the heating roller 10. In such configurations, the surface of the heating roller 10 may be painted with black heat-resistant coating so as to improve the absorption of the light radiated from the heating light sources 34 to increase the heating efficiency.

10. Since a water-repellent coating 15 is formed around the heating roller 10, the adhesion of ink to the heating roller 10 can be prevented even when the heating roller 10 comes into contact with the print medium 8, preventing the print medium 8 from getting stained.

11. Since the corners of the heating roller 1 are tapered or curved, the difference in ink evaporation between the dry portion and the wet portion of the print medium 8 is small, the wrinkles or geometrically discontinuous portions at the edge of the print medium 8 are reduced.

12. Here, when drying a portion of the print medium 8, wrinkles or geometrically discontinuous portions are prone to occur in the print medium 8 where the portion of the print medium 8 dried by the heating roller 1 and the portion that has not been dried meet because the portion that has not been dried is wet with ink that causes the cellulose fibers of the print medium 8 to swell.

13. Although this embodiment shows an example wherein the corners of the heating roller 10 cross are tapered or curved to prevent wrinkles or geometrically discontinuous portions at the boundary between the print medium 8 where the ink has and has not been dried, the invention is not limited to such configurations. For example, as shown in FIG. 16, the wrinkles or discontinuous portions may be prevented by forming the heating roller 10 in a crown shape wherein the circumference of the heating roller 10 increases in diameter from the ends to the center.

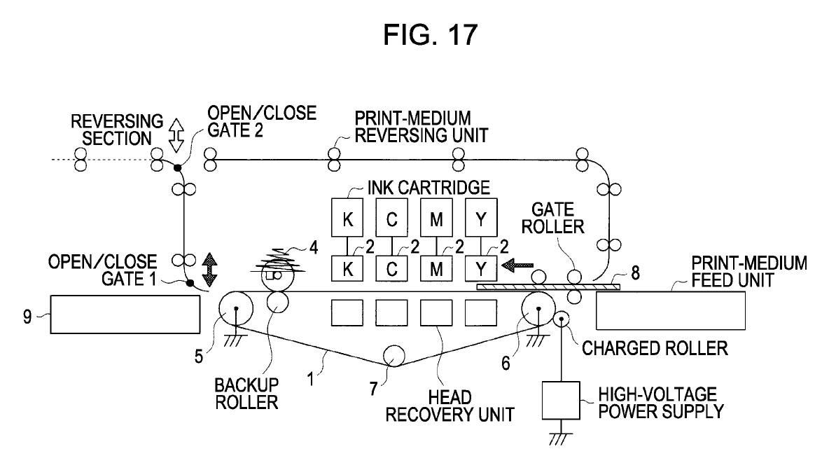

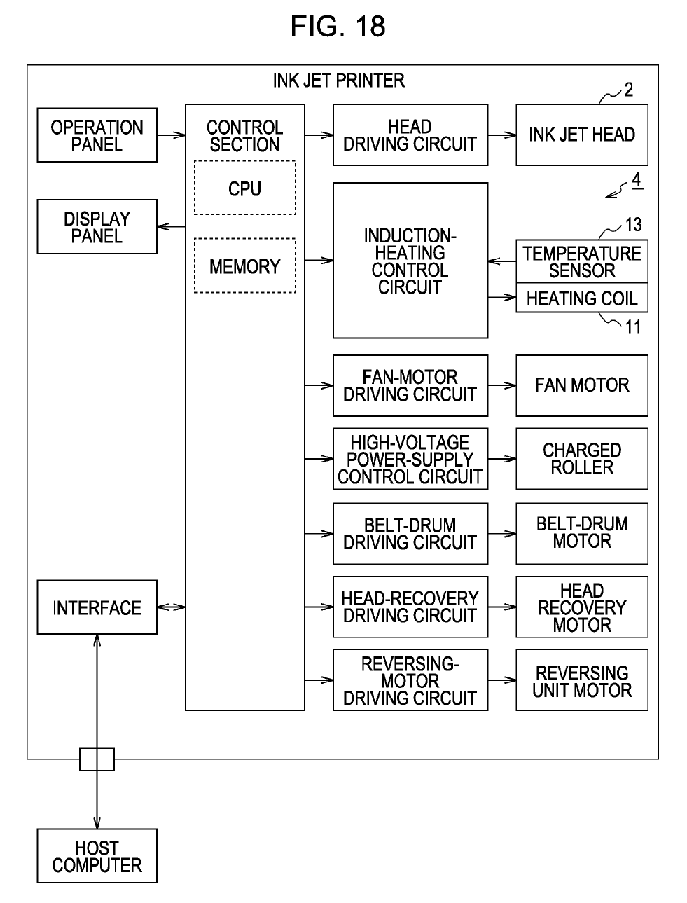

Although the invention is described in association with a single-sided ink jet printer, the invention is not limited to these configurations, and may be used in other configurations, including double-sided ink jet printers, as shown in FIGS. 17 and 18.

FIG. 17 is a schematic diagram of a double-sided ink jet printer. FIG. 18 is a block diagram showing the internal structure of this ink jet printer.

### Second Embodiment

A second embodiment of the invention will be described with reference to the drawings.

The second embodiment differs from the first embodiment only in that the print medium 8 is dried after printing without making contact with the print medium 8.

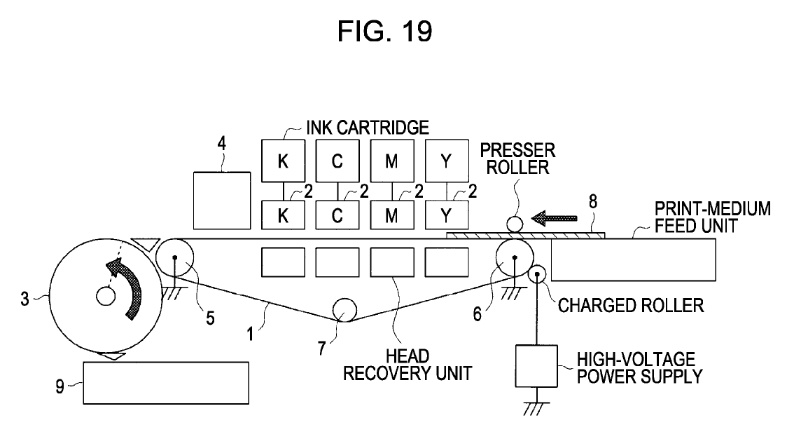

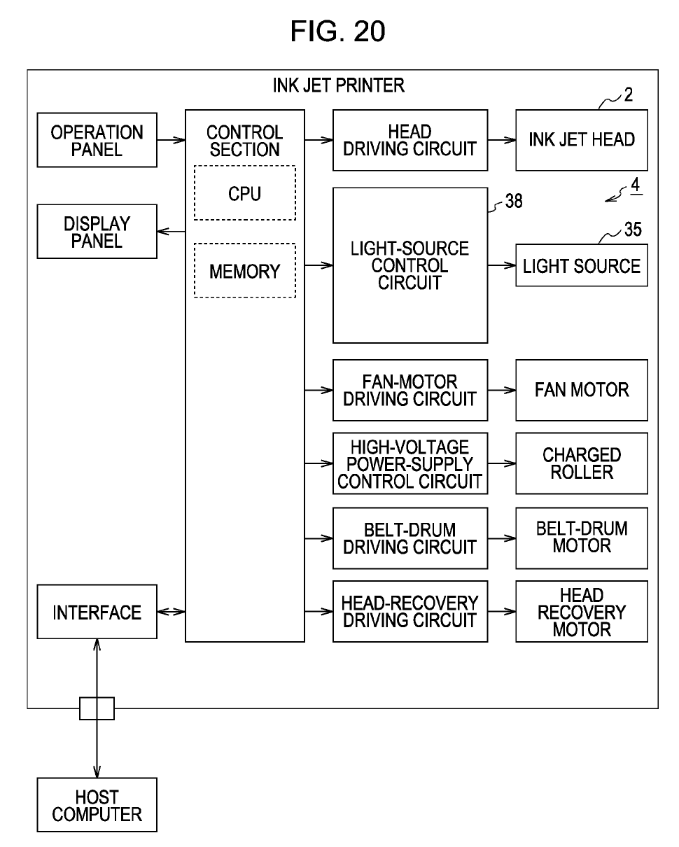

FIG. 19 is a schematic diagram of a single-sided ink jet printer of this embodiment. FIG. 20 is a block diagram showing the internal structure of the ink jet printer. As shown in FIG. 19, the ink jet printer of the second embodiment differs from the first embodiment in the arrangement and structure of the heating unit 4.

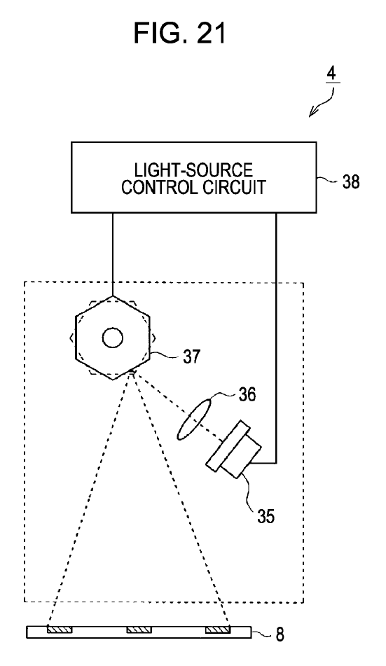

FIG. 21 is a schematic diagram of the heating unit 4 of this embodiment of the invention. As shown in FIG. 21, the heating unit 4 includes a light source 35, an optical system 36, a polygon mirror 37, and a light-source control circuit 38.

The light source 35 is formed of a semiconductor laser or a light emitting diode (LED), which emits light in the visible to infrared range to a portion of the print medium 8 via the optical system 36 and the polygon mirror 37 according to an instruction output from the light-source control circuit 38.

The optical system 36 converges the light emitted from the light source 35 and applies it to part of the print medium 8 via the polygon mirror 37 so as to heat and dry a portion of the print medium 8.

The polygon mirror 37 includes a polyhedron reflecting mirror and a motor, in which the polyhedron reflecting mirror is rotated by the motor so that the light traveling out from the optical system 36 is reflected by the surface of the polyhedron reflecting mirror to part of the print medium 8 according to an instruction output from the light-source control circuit 38.

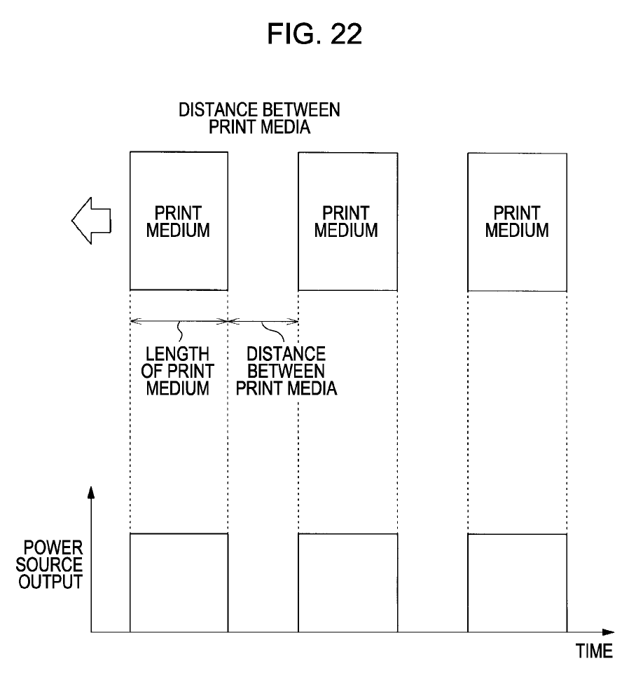

FIG. 22 illustrates the timing for emitting light from the light source 35.

The light-source control circuit 38 outputs an instruction to the light source 35 to emit light only when the print medium 8 is at the destination of the light so that part of the print medium 8 is irradiated with the light, as shown in FIG. 22. Thus, when there is no print medium 8 at the destination of the light emitted from the light source 35, the light-source control circuit 38 outputs an instruction to turn off the light source 35 so as not to emit light or an instruction to rotate the polygon mirror 37.

Thus, in this embodiment, the heating unit 4 of FIG. 21 comprises a noncontact drying device.

Advantages of this embodiment will be described below.

14. Since the ink jet printer of this embodiment is configured to dry only a portion of the print medium 8 after printing without contacting the print medium 8, the rigidity of the print medium 8 can be restored, and the print medium 8 may prevented from getting stained while reducing the energy required for drying.

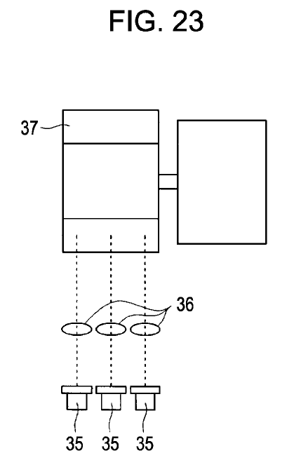

Although this embodiment uses only one light source 35 to dry the print medium 8, the invention is not limited to that configuration. For example, three parallel light sources 35 may be used for one polygon mirror 37, as shown in FIG. 23.

15. Since the ink jet printer is configured to dry only a portion of the print medium 8 along the width of the print medium 8 (orthogonal to the transportation direction) the rigidity of the print medium 8 can be increased more appropriately.

16. Moreover, since the ink jet printer is configured to emit light in the visible to infrared range from the light source, converge the emitted light by the optical system, and rotate the polygon mirror 37 so that the converged light is reflected to part of the print medium 8, a desired portion of the print medium 8 can easily be dried.

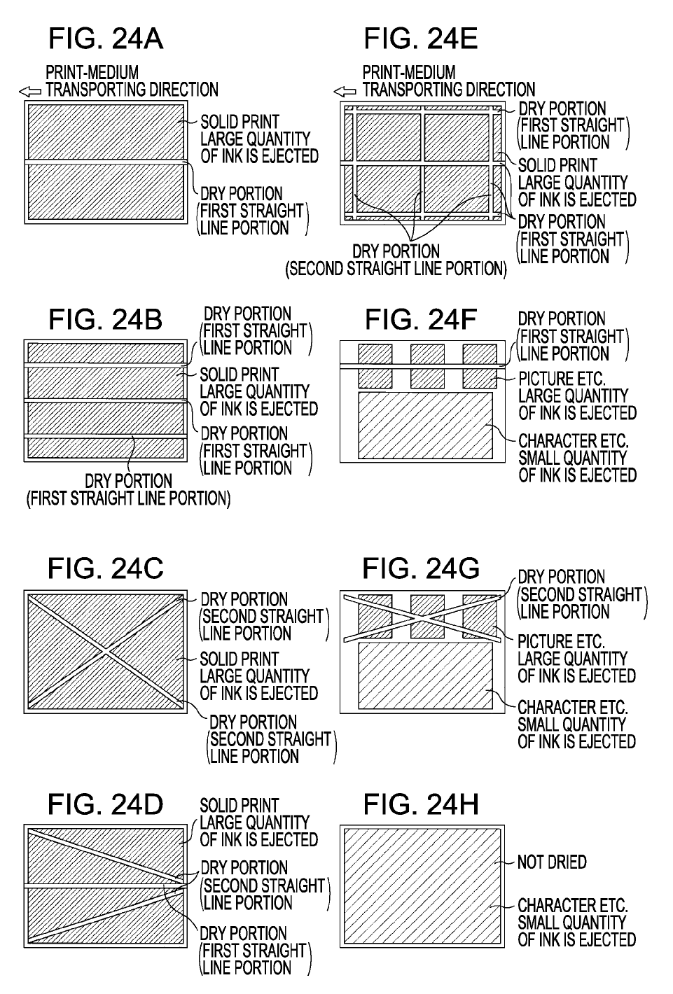

17. For example, as shown in FIGS. 24A to 24G, a variety of drying patterns may be used to dry the print medium 8, which improve the rigidity of the print medium 8.

18. Examples of drying patterns that may be achieved by rotating the polygon mirror 37 so as to adequately dry the portion of the print medium 8 where the ink is most dense are shown in FIGS. 24A to 24G. In other words, the invention may be configured to select a drying pattern depending on the state of ejection of ink drops onto the print medium 8, and to continuously dry the selected portion in the direction of transportation of the print medium 8. This allows the print medium 8 to be dried according to the state of the ink.

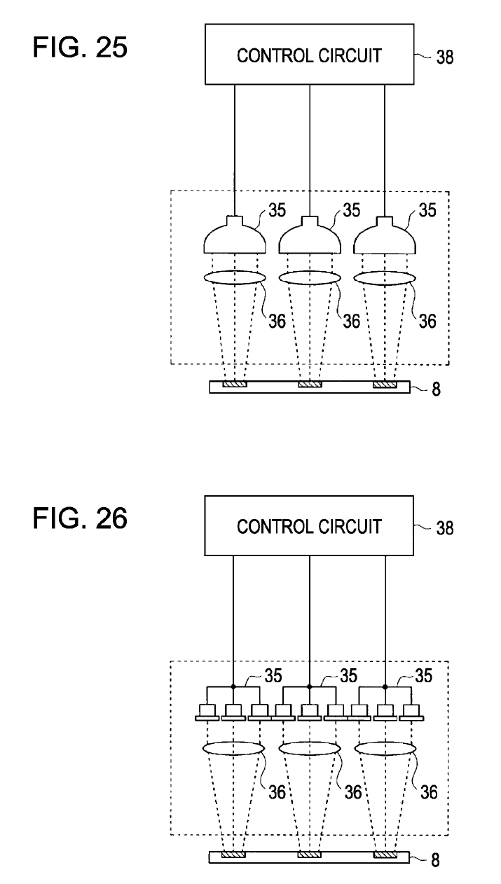

19. Although this embodiment shows a configuration in which part of the print medium 8 is irradiated with light through the polygon mirror 37, the invention is not so limited. For example, as shown in FIG. 25, two or more light sources 35 may be used to emit visible infrared, mid-infrared, and far-infrared light. The light sources 35 may be opposed to the print medium 8 and the light emitted from the light sources 35 may be converged by the optical systems 36 onto part of the print medium 8 so that only part of the print medium 8 is dried. This structure can omit the mechanism required to rotate the polygon mirror 37.

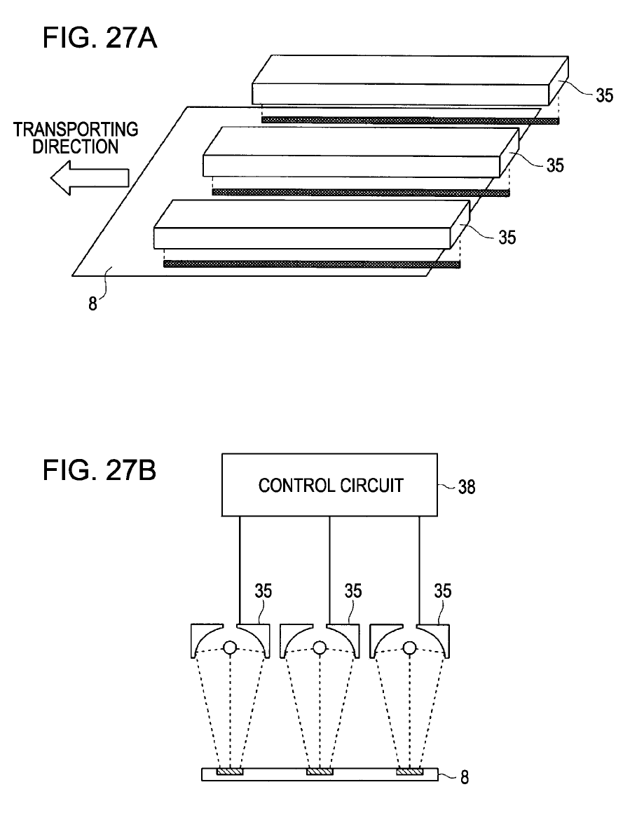

In the case where the light emitted from the light sources 35 is converged by the optical systems 36 and is applied directly to the print medium 8, two or more light sources 35 may be disposed for one optical system 36, as shown in FIG. 26, or alternatively, long halogen lamps extending along the transportation direction may be used as the light sources 35, as shown in FIGS. 27A and 27B.

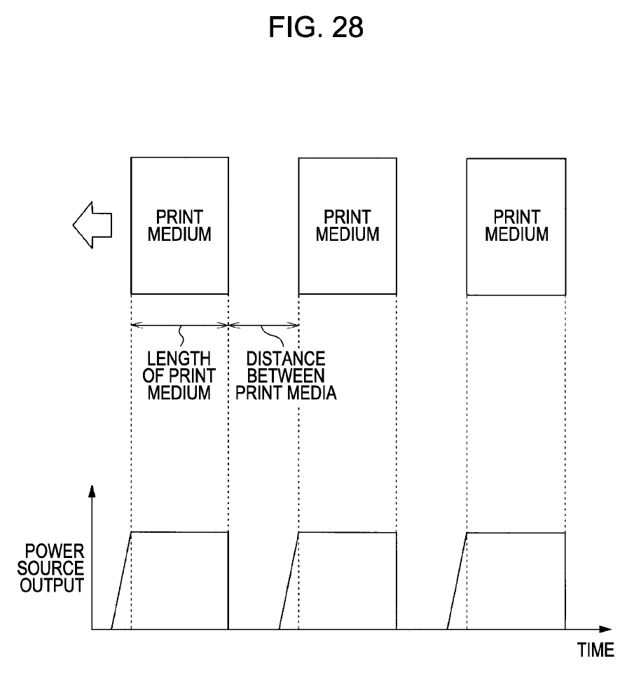

20. As shown in FIG. 22, light is emitted from the light source 35 only when the print medium 8 is located at the destination of the light. Otherwise, no light is emitted from the light source 35. This structure prevents the transportation belt 1 from being irradiated with the light from the light source 35 when there is no print medium 8 on the transportation belt 1, thus preventing the transportation belt 1 from being heated. In the case where a low-response light source, such as a halogen lamp, is used as the light source 35 (which requires a warming time of about one second from application of voltage to emission of light), the light source 35 must be turned on before the print medium 8 is transported to the destination of the light emitted from the light source 35 (FIG. 28).

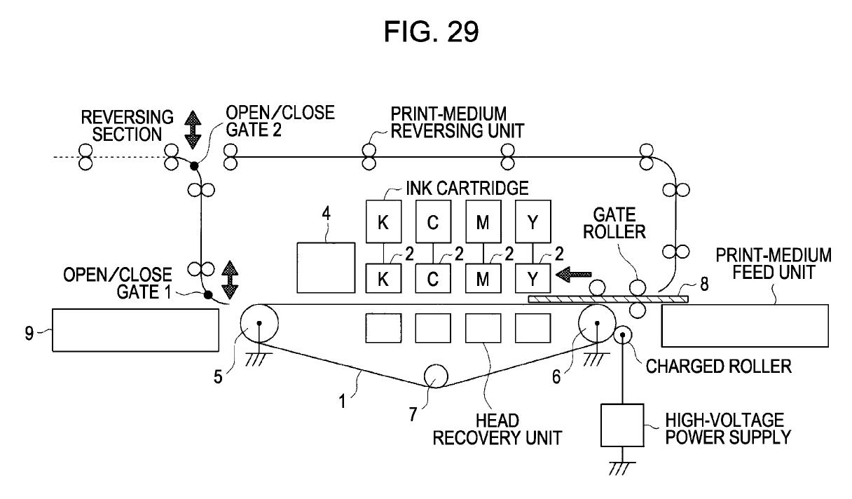

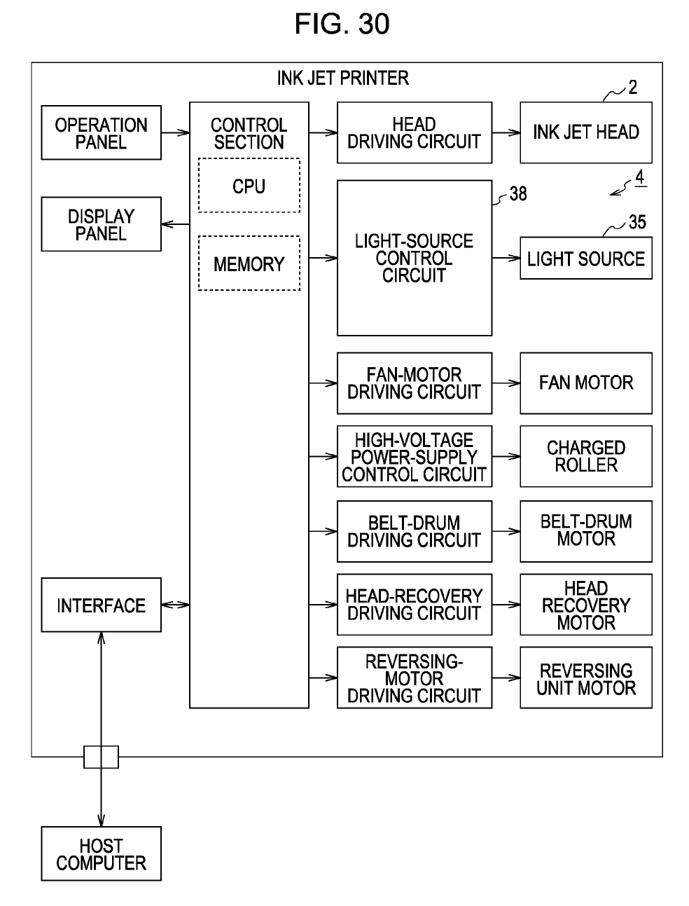

21. Although this embodiment shows an application to a single-sided ink jet printer, the invention is not so limited. For example, the invention may be applied to the double-sided ink jet printer shown in FIGS. 29 and 30.

### Third Embodiment

A third embodiment of the invention will be described with reference to the drawings.

The third embodiment differs from the first embodiment in that in the first embodiment where the drying pattern is set according to the state of the ink drops on the print medium 8.

The ink jet printer of the third embodiment is different from the first embodiment in the structure of the heating unit 4.

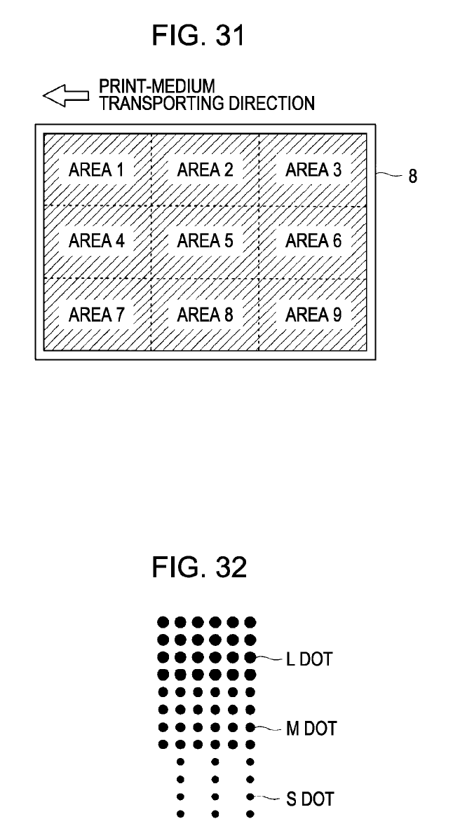

As shown in FIG. 13, three heating units 4 are arranged in parallel around the rotating drum 3. During each printing process, a control process, described more fully below, is executed, wherein a determination is made for each printed area (of nine areas obtained by dividing the print medium 8 into three rows of three areas, as shown in FIG. 31) whether the weight of ejected ink is larger than a threshold value. If so, a drying pattern is selected so as to dry the printed areas whose ink weight is determined to be larger than the threshold value.

As shown in FIG. 31, the printed areas at the right end in the print-medium transporting direction are referred to as areas 1 to 3 from the head of the print medium 8, those in the middle are referred to as areas 4 to 6 from the head, and those at the left end are referred to as areas 7 to 9 from the head.

As shown in FIG. 32, ink drops ejected from the ink jet heads 2 may be L dots, M dots, or S dots of different sizes.

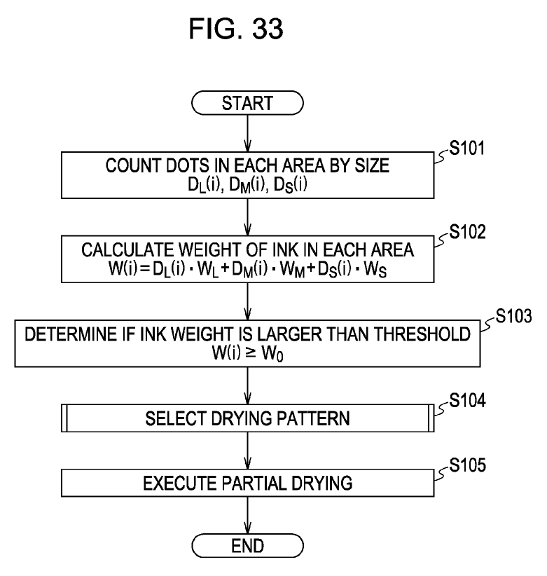

The control process performed during each printing process that is executed by the light-source control circuit 38 will next be described with reference to FIG. 33. At S101, the numbers by size of dots of ejected ink drops D_{L}(i), D_{M}(i), and D_{S}(i) (i=1 to 9) are counted for each printed area ((D_{L}(i) is the number of L dots ejected to area i, D_{M}(i) is the number of M dots ejected to area i, and D_{S}(i) is the number of S dots ejected to area i).

Then, at S102, the light-source control circuit 38 calculates the total weight of the ink drops (ink weight) ejected to each printed area from the numbers by size of dots D_{L}(i), D_{M}(i), and D_{S}(i) counted in S101 using the following Eq. 3:

W(i)=D_{L}(i)·W_{L}+D_{M}(i)·W_{M}+D−_{S}(i)·W_{S} Eq. 3

where, W_{L} is the weight of L-dot ink drops, W_{M} is the weight of M-dot ink drops, and W_{S} is the weight of S-dot ink drops.

At S103, it is determined whether the ink weight W(i) calculated in S102 is larger than a threshold value W_{O}.

Then, at S104, a pattern setting process (described more fully below) for setting a drying pattern according to the determination at S103 is executed.

The process moves to S105, wherein the print medium 8 is partially dried by the heating unit 4 in the printed area corresponding to the drying pattern set in S104, and the calculating process is completed.

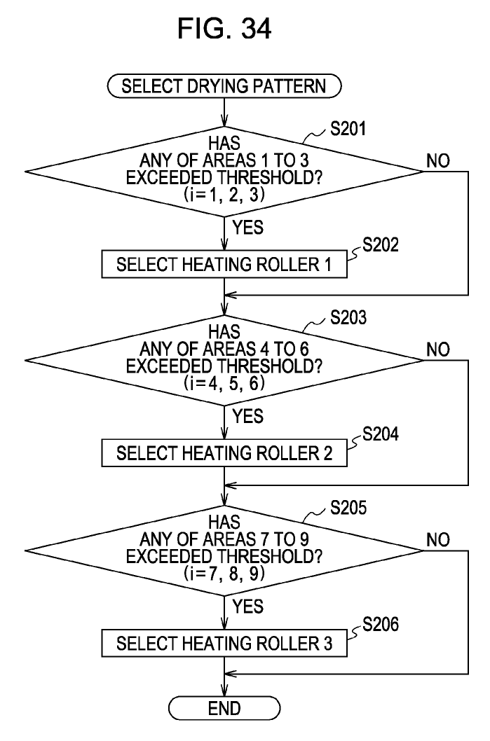

The pattern setting process will now be described with reference to FIG. 34. First, at S201 it is determined whether the ink weight in any of areas 1 to 3 is larger than a threshold value. If the weight the ink of any of areas 1 to 3 is larger than the threshold value (Yes), the process moves to S202. If the weight of the ink in any of areas 1 to 3 is less than the threshold value (No), the process moves to S203.

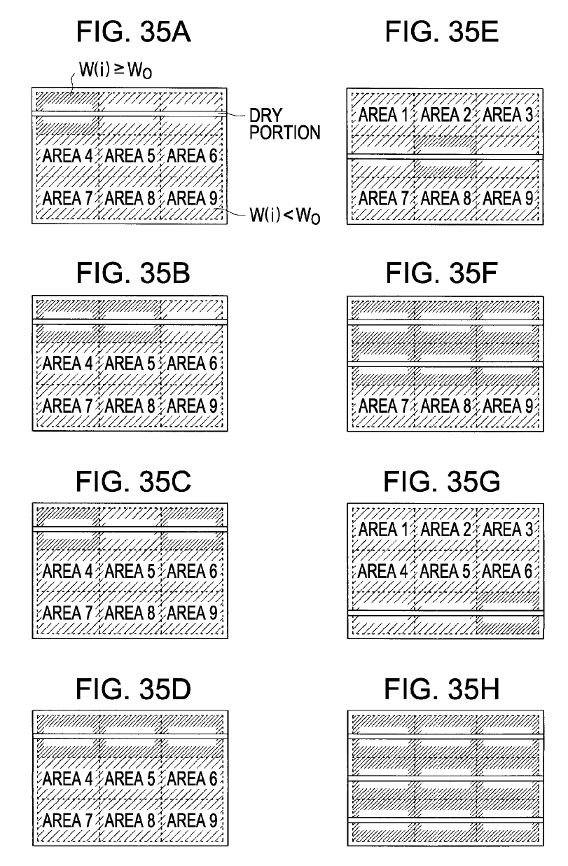

At S202, as shown in FIGS. 35A to 35D, a drying pattern for drying areas 1 to 3 is set (a drying pattern is selected for the to use the heating unit 4 on areas 1 to 3) and then the process moves to S203.

In S203, a determination is made as to whether the ink weight in any of areas 4 to 6 is larger than the threshold value. If the weight of the ink in any of areas 4 to 6 is larger than the threshold value (Yes), the process moves to S204, whereas if the weight of the in any of areas 4 to 6 is less than the threshold value (No), the process moves to S205.

At S204, a drying pattern for drying areas 4 to 6 is set, such as the pattern shown in FIG. 35E, and then the process moves to S205. If a drying pattern for drying areas 1 to 3 has been set in S202, a drying pattern, such as the pattern shown in FIG. 35F, is for drying areas 1 to 6, and then the process moves to S205.

At S205, a determination is made as to whether the weight the ink of any of areas 7 to 9 is larger than the threshold value. If the ink weight of any of areas 7 to 9 is larger than the threshold value (Yes), the process moves to S206. If the weight of the ink in any of areas 7 to 9 is less than the threshold value (No), the process returns to S201.

At S206, a drying pattern for drying areas 7 to 9 is set, such as the pattern shown in FIG. 35G, and then the calculation process is completed.

If a drying pattern for only drying areas 1 to 3 has been set at S202, a drying pattern for drying areas 1 to 3 and areas 7 to 9 is set, and then the calculation process is completed.

If a drying pattern for drying only areas 4 to 6 has been set at S204, a drying pattern for drying areas 4 to 9 is set, and then the calculation process is completed.

If a drying pattern for drying areas 1 to 6 has been set at S204, a drying pattern, such as the pattern shown in FIG. 35H, is set for drying areas 1 to 9, and the calculation process is completed.

In this embodiment, the heating unit 4 in FIG. 1 comprises the drying device, and the steps S201 to S206 in FIG. 34 correspond to a drying-pattern setting section and the drying executing section. Likewise, steps S201, S203, and S205 in FIG. 34 correspond to the determining section, and steps S202, S204, and S206 in FIG. 34 correspond to the setting section.

The advantages of this embodiment will be described herein below.

22. The ink jet printer of this embodiment is configured to set a drying pattern for the print medium 8 after printing, which depends on the density or weight of ink drops on the print medium 8, so as to dry part of the print medium 8 where the ink is the densest. This restores the rigidity of the print medium 8 that has been decreased because of ink and allows the print medium 8 to be dried while reducing the energy required for drying.

23. The ink jet printer is configured to determine whether or not the weight of ejected ink is larger than a threshold value for each printed area, and to set a drying pattern for drying a printed area whose ink weight is determined to be larger than the threshold value by a heating unit 4. This further reduces the energy required for drying.

24. Although the embodiment is configured to determine whether or not the weight of ejected ink is larger than a threshold value for each printed area, the invention is not limited to such configurations. For example, the invention may be configured to determine whether or not the weight of ejected ink is larger than a threshold value for each printed area at the top of the print medium 8 and to set a drying pattern for drying a printed area whose ink weight is determined to be larger than the threshold value. This further reduces the energy required for drying.

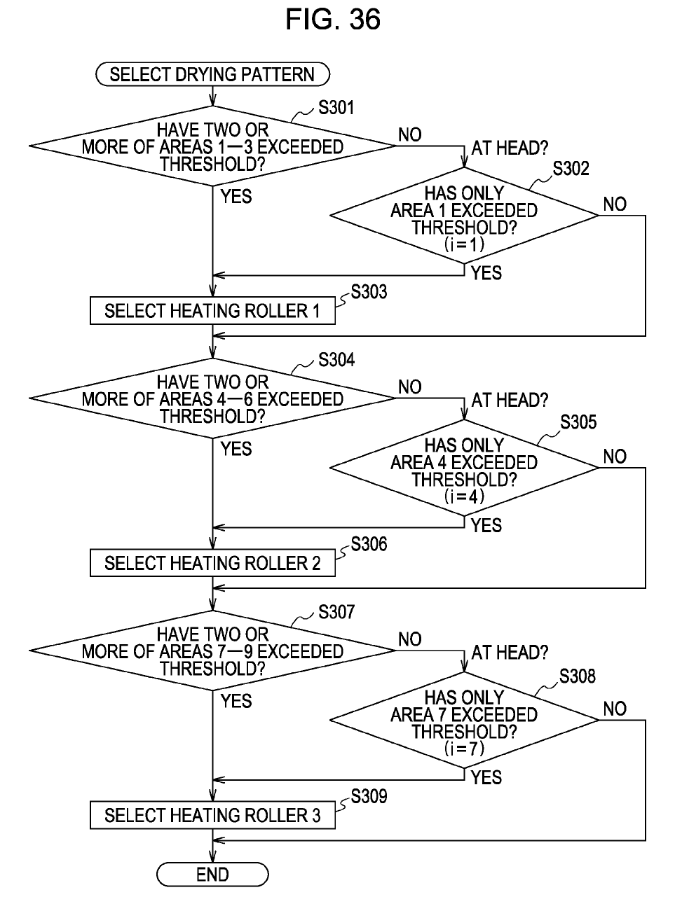

Specifically, in the pattern setting process shown in FIG. 36, it is first determined whether there are two or more printed areas in areas 1 to 3 whose ink weight is larger than a threshold value. If there are two or more printed areas whose ink weight is larger than the threshold value (Yes), the process moves to S303, and if there is less than two printed areas whose ink weight is larger than the threshold value (No), the process moves to S302.

At S302, a determination is made as to whether the ink weight W(1) of area 1 is larger than the threshold value W_{O}. If the ink weight W(1) of area 1 is larger than the threshold value W_{O} (Yes), the process moves to S303. If the ink weight W(1) of area 1 is less than the threshold value W_{O} (No), the process moves to S304.

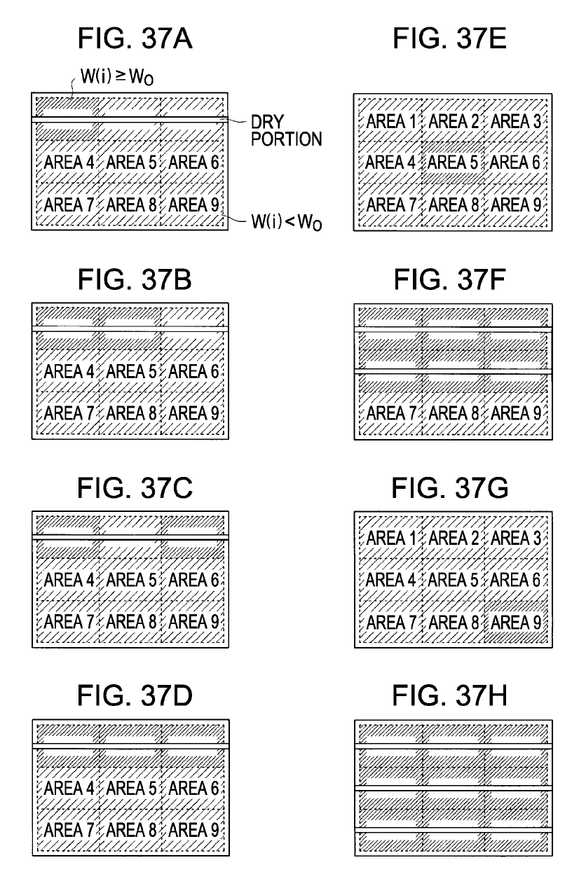

At S303, a drying pattern for drying areas 1 to 3 is set which corresponds to drying areas 1 to 3, as shown in FIGS. 37A to 37D, and then the process moves to S304.

At S304, a determination is made to determine if two or more of the areas 4 to 6 have an ink weight that is larger than a threshold value. If there are two or more printed areas whose ink weight is larger than the threshold value (Yes), the process moves to S306, while if there is less than two printed areas whose ink weight is larger than the threshold value (No), the process moves to S305.

At S305, a determination is made as to whether the ink weight W(4) of area 4 is larger than the threshold value W_{O}. If the ink weight W(4) of area 4 is larger than the threshold value W_{O} (Yes), the process moves to S306, and if the ink weight W(4) of area 4 is less than the threshold value W_{O} (No), the process moves to S307.

At S306, a drying pattern for drying areas 4 to 6 is set, and then the process moves to S307.

In other words, if the weight of ink ejected to the head printed area (area 4) in the transportation direction is less than the threshold value, a drying pattern is set where areas 4 to 6 are not dried, such as the pattern shown in FIG. 37E, even if the ink weights of areas 5 and 6 are larger than the threshold value.

If a drying pattern for drying areas 1 to 3 has been set in S303, a drying pattern for drying areas 1 to 6 is set, as shown in FIG. 37F, and then the process moves to S307.

At S307, a determination is made to determine whether two or more of the areas of areas 7 to 9 have an ink weight that is larger than a threshold value. If there are two or more printed areas whose ink weight is larger than the threshold value (Yes), the process moves to S309, and if there is less than two printed areas whose ink weight is larger than the threshold value (No), then the process moves to S308.

At S308, a determination is made to determine if the ink weight W(7) of area 7 is larger than the threshold value W_{O}. If the ink weight W(7) of area 7 is larger than the threshold value W_{O} (Yes), the process moves to S309. If the ink weight W(7) of area 7 is less than the threshold value W_{O} (No), the calculation process is completed.

In S309, a drying pattern for drying areas 7 to 9 is set, and then the calculation process is completed.

In other words, if the weight of ink ejected to the head printed area (area 7) in the transporting direction is less than the threshold value, then a drying pattern that does not dry areas 7 to 9 is set, such as the pattern shown in FIG. 37G, even if the weight of ink ejected to the other printed areas (areas 8 and 9) corresponding to the same heating unit 4 is larger than the threshold value.

If only the drying pattern for drying areas 1 to 3 has been set in S303, a drying pattern for drying areas 1 to 3 and areas 7 to 9 is set, and then the calculation process is completed.

If a drying pattern for drying only areas 4 to 6 has been set in S306, a drying pattern for drying areas 4 to 9 is set, and then the calculation process is completed.

If a drying pattern for drying areas 1 to 6 has been set in S306, a drying pattern for drying areas 1 to 9 is set, such as the pattern shown in FIG. 37H, and then the calculation process is completed.

25. Although the embodiment shows an example in which a drying pattern for the print medium 8 is set according to the state of the ink drops onto the print medium 8, the invention is not so limited. For example, the invention may have a mode setting function for setting a first mode wherein a portion of the print medium 8 is dried according to the density of ink on the print medium 8 and a second mode wherein the print medium 8 is dried according to a predetermined drying pattern. Thus, a portion of the print medium 8 can be dried based on the density of ink used during the printing process, whereas a second portion of the print medium 8 is dried according to a predetermined drying pattern.

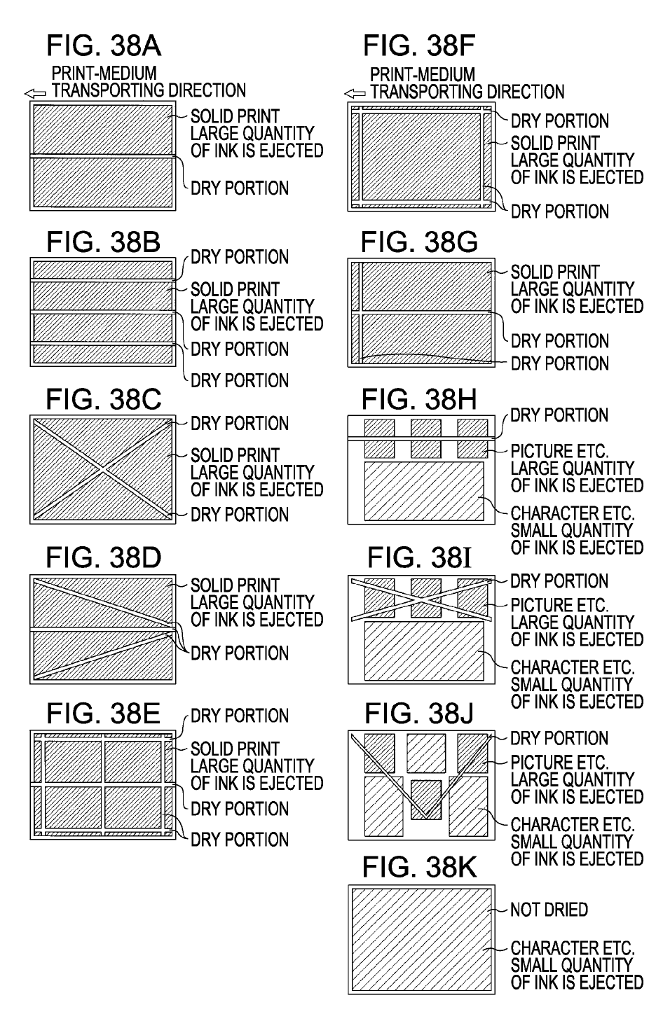

Examples of the predetermined patterns where a large quantity of ink is ejected on the print medium are shown in FIGS. 38A to 38J.

In this configuration, the heating unit 4 dries the print medium 8 by contacting the print medium 8. The invention, however, is not limited to such configurations, and other heating units 4, such as the heating unit 4 of the second embodiment, may be used.

What is claimed is:

1. An ink jet printer comprising:
a transporting device that is capable of transporting a print medium with a predetermined width in a first direction;
an ink jet head that is capable of ejecting ink drops onto the print medium during a printing process; and
a drying device that is capable of drying a portion of the print medium, wherein
the portion of the print medium comprises a line pattern with a width that is smaller than the width of the print medium which extends from an end of the print medium to a second end of the print medium in the first direction.

2. The ink jet printer according to claim 1, wherein the drying device comprises a heating roller with a width that is smaller than the predetermined width of the print medium; and
a roller heating device that is capable of heating the heating roller.

3. The ink jet printer according to claim 2, wherein the heating roller comprises magnetic metal and the roller heating device comprises a heating coil capable of heating the heating roller by an eddy current.

4. An ink jet printer comprising:
a transporting device that is capable of transporting a print medium with a predetermined width in a first direction;
an ink jet head that is capable of ejecting ink drops onto the print medium to execute a printing process;
a drying-pattern setting section that is capable of selecting a drying pattern for drying the printed print medium by evaluating the ink drops ejected on the print medium; and
a drying executing section that is capable of drying a portion of the print medium corresponding to the selected drying pattern.

5. The ink jet printer according to claim 4, wherein the drying-pattern setting section comprises:
a determining section that is capable of determining whether or not the weight of the ejected ink drops is larger than a threshold value for a plurality of printed areas within the print medium; and
a setting section that is capable of selecting a drying pattern for drying any printed area from the plurality of printed areas whose ink weights are determined to be larger than the threshold value by the determining section.

6. The ink jet printer according to claim 4, further comprising:
a second drying-pattern setting section that is capable of selecting a predetermined drying pattern; and
a mode setting section that is capable of setting a first mode wherein a portion of the print medium is dried according to the drying pattern set by the drying-pattern setting section or a second mode wherein a portion of the print medium is dried according to the drying pattern set by the second drying-pattern setting section, wherein
the drying executing section dries a portion of the print medium according to the drying pattern set by the drying-pattern setting section when the first mode is selected by the mode setting section, and a second portion of the print medium is dried according to the drying mode set by the second drying-pattern setting section.

7. The ink jet printer of claim 4 wherein the drying executing section comprises heating roller with a width that is smaller than the predetermined width of the print medium that is capable of drying a portion of the print medium; and
a roller heating device that is capable of heating the heating roller.

8. The ink jet printer according to claim 7, wherein the heating roller comprises magnetic metal and the roller heating device comprises a heating coil capable of heating the heating roller by an eddy current.

9. An ink jet printer comprising:
a transporting device that is capable of transporting a print medium with a predetermined width in a first direction that is orthogonal to the width of the print medium;
an ink jet head that is capable of ejecting ink drops onto the print medium to execute a printing process;
a heating roller with a width that is smaller than the predetermined width of the print medium that is capable of drying a portion of the print medium; and
a roller heating device that is capable of heating the heating roller.

10. The ink jet printer according to claim 9, wherein the heating roller comprises magnetic metal and the roller heating device comprises a heating coil capable of heating the heating roller by an eddy current.

11. The ink jet printer according to claim 9, wherein the outer circumference of the heating roller has a water-repellent coating that is in contact with the print medium.

12. An ink jet printer comprising:
a transporting device that is capable of transporting a print medium with a predetermined width to a first direction;
an ink jet head that is capable of ejecting ink drops onto the print medium to execute a printing process; and
a drying device that is capable of drying a portion of the printed print medium without making contact with the print medium.

13. The ink jet printer according to claim 12, wherein the drying device comprises:
a light source that is capable of emitting light in the visible to infrared range;
an optical system that is capable of converging the light emitted from the light source; and
a polyhedron reflecting mirror that is capable of being rotated so as to reflect the light converged by the optical system toward a portion of the print medium so as to dry a portion of the print medium.

14. The ink jet printer according to claim 13, wherein the drying device is configured to allow the light source to emit light only when the print medium is located at the destination of the light emitted from the light source and does not allow the light source to emit light when the print medium is not located at the destination of the light emitted from the light source.
